(19) United States
(12) Patent Application Publication
(10) Pub. No.: US 2009/0187941 A1
(43) Pub. Date: Jul. 23, 2009

(54) SYSTEM AND METHOD FOR TARGETED ADVERTISING

(75) Inventor: Donald Smith, San Ramon, CA (US)

Correspondence Address: AT&T Legal Department - Roebuck;Attn: Patent Docketing, One AT&T Way,, Room 2A-207, Bedminster, NJ, 07921, US

(73) Assignee: ATT Knowledge Ventures L.P., Reno, NV (US)

(21) Appl. No.: 12/017,245

(22) Filed: Jan. 21, 2008

(51) Int. Cl. H04N 7/081; H04N 7/173

(52) U.S. Cl. 725/35; 725/105

(57) ABSTRACT

A computer readable medium is disclosed containing embedded computer executable instructions that when executed by a computer or router or switch are useful in performing a method for sending targeted advertising data, the computer program comprising instructions to receive a first data set at a server; instructions to duplicate the data to form N duplicated data sets; instructions to replace a source address in each of the N duplicated data sets with a different one of a number, N data source addresses; and instructions to send each of the N duplicated data sets to a different end user zone. A system and method for sending targeted advertising data are disclosed. A data structure for containing data used by the system and method is also disclosed.

### FIELD OF THE DISCLOSURE

The present disclosure relates to the field of targeted advertising.

### BACKGROUND OF THE DISCLOSURE

Targeted advertisements have historically been mailed to large targeted geographic areas such as a particular city, so that regional advertisers reach only persons who are deemed by the advertiser as most likely to be responsive to their advertisements. Advertisements are a component in digital video services, including live or pre-recorded broadcast television TV, special or pay-per-view programming, video on demand (VOD), and other content choices available to subscribers. Advertisers now target video subscribers with advertisements based on demographics for regions in which the subscriber resides.

### BRIEF DESCRIPTION OF THE DRAWINGS

FIG. 1 depicts an illustrative embodiment of a system for delivering advertising data; note that the multicast network is not necessarily fiber optic; it could be copper or a combination;

FIG. 2 depicts an illustrative embodiment of a system for delivering advertising data;

FIG. 3 depicts a flow chart of functions performed in an illustrative method for delivering advertising data;

FIG. 4 depicts a flow chart of functions performed in another illustrative method for delivering advertising data;

FIG. 5 depicts a data structure embedded in a computer readable medium that is used by a processor and method for delivering advertising data; and

FIG. 6 depicts an illustrative embodiment of a machine for performing functions disclosed in an illustrative embodiment.

### DETAILED DESCRIPTION

An illustrative embodiment will be described in the context of an internet protocol television (IPTV) system in which video data services, voice over internet protocol, internet data services and mobile/WiFi data connectivity are provided to client devices. In the IPTV system, IPTV video data are first broadcast internet protocol (IP) packets from a server at a super hub office (SHO) to a regional or local IPTV video hub office (VHO). The IPTV system includes a hierarchically arranged network of routers and switches wherein the SHO transmits video and advertising data to a video hub office (VHO), and the VHO transmits to an IPTV router or switch closer to a subscriber. In another particular embodiment, the hierarchy consists of a SHO, VHOs, (intermediate offices) IOs, central offices (COs), digital subscriber line multiplexers (DSLAMs) or passive optical subscriber line splitters/multiplexers which are interconnected with an IPTV transport network. The IPTV transport may consist of routers and switches interconnected with high speed fiber optic and/or metallic cables for transmission of internet protocol (IP) data. The IPTV network also provides data communication for data and video associated with Internet and VoIP services to subscribers. IPTV channels are sent via Internet protocol (IP) multicast through the IPTV network hierarchy to the subscriber premises equipment, such as residential gateways (RGs) and IPTV client devices, such as set top boxes (STBs) or digital video recorders (DVRs).

Previously, in some systems it was assumed that for each channel subject to advertising data insertion, the advertising server must generate a separate multicast group address, G, for each of the multicast streams going to different zones, since each advertising inserted channel is customized with the advertising data for that zone, and subscribers use G to identify the channels. In an illustrative embodiment, for a channel subject to advertising data insertion, an advertising data insertion unit generates output streams with the same G for all the zones. The streams going to the different zones must be separately identifiable. In an illustrative embodiment, a separate multicast source address, S for each zone is provided. The separate multicast source addresses are generated by the advertising data insertion unit, which forwards the streams having a new multicast source address to a router. The router forwards the separate multicast streams to their respective zones based on the multicast source addresses of the streams and a mapping that associates the Gs with the Ss. In this way, since the multicast group address, G, of the advertising data inserted streams is the same for all the different zones, advertising data insertion is transparent to the downstream IPTV system and to the network elements and to the client devices, even though the contents of the streams are different for the different zones.

In an illustrative embodiment, instead of generating a separate G for each zone, the advertising data insertion unit generates a separate multicast source address S for each zone, keeping G the same for all zones. The output of the advertising data insertion unit is a set of advertising data inserted streams with separate Ss for each zone which are sent to a router which multicasts to its multicast egress interfaces. There are one or more egress interfaces per zone. For each such interface belonging to a particular zone, the router is configured to send the stream with a particular S that belongs to the particular zone, for each G. Subscribers or client devices send requests for a particular stream based on the G of the stream. The subscribers have no knowledge of the S. The router associates the correct S with that G. In an illustrative embodiment, zoned advertising data insertion is provided by configuring the Ss on a per interface basis to match the zones for those interfaces. This is implemented in various ways at the router, for example, direct configuration of G to S mapping (sometimes referred to as source specific multicast translation (SSM-translation) or source specific multicast mapping), or a filter policy that filters out all the Ss except for the desired ones for the particular interface.

In another illustrative embodiment, a Microsoft IPTV environment is provided with distribution servers (D-Servers) and an additional feature is provided in the advertising data insertion unit. Microsoft's resilient UDP (R-UDP) packet recovery protocol runs between the D-servers and the clients devices. Furthermore, the IP packets carry RTP (Real Time Protocol) packets within them. Various types of data carried within the multicast streams may be used for unique identification of streams for the purposes of lost packet recovery mechanisms. One example of this data is the SSRC field in the RTP header. In a particular illustrative embodiment, the client devices use the synchronization source (SSRC) in the real time transport protocol (RTP) header to identify streams. To support this, for each advertising data inserted channel, the advertising data insertion unit generates a separate SSRC for each zone. Other implementations may use data other than SSRC, or SSRC combined with other data being carried within the multicast streams to uniquely identify the multicast streams. In those other implementations, the advertising data insertion unit generates unique values of the stream identification data for each zone. For generality, in the following sections, the data used to uniquely identify ad inserted streams of the different ad zones for the purposes of R-UDP between D-servers and clients will be referred to as stream-identifier-data. In some past designs for zone-based local advertising data insertion, an advertising data insertion system was provided an input stream with multicast group G(i) for each channel from the SHO (typically referred to as a national channel) subject to local ad insertion, and the output of the advertising data insertion system generated a multiplicity of ad inserted streams for each G(i), each with its own unique multicast group G(i,z), where z is a zone index (there is a z for each zone). In a system in which the zones are central office (CO) based, a zone consists of one or more COs. An issue with this design is that it significantly increases the provisioning complexity for the IPTV client devices and client access nodes. (Examples of access nodes are digital subscriber line multiplexers (DSLAMs) or passive optical subscriber line splitters/multiplexers.) Specifically, the configuration of each client's service-id to multicast G mapping for the advertising data inserted channels needs to be customized according to the client's zone. (Each video channel is associated with a service-id.) Similarly, the permitted multicast group list (sometimes referred to as the white list) in the access node configurations needs to be customized according to the zone in which the access node resides. In a particular illustrative embodiment, for a given G(i) input to the local advertising data insertion unit, all the advertising data inserted output streams for the zones have the same multicast group G(i) as the input.

The SHO A-server encrypts the audio/video payload of the multicast streams, and boundary keys, in IPTV terminology, are used by the clients to decrypt the payload of the streams. In a particular illustrative embodiment, there is no need to generate separate boundary keys for the advertising data inserted streams going to the different ad zones. The boundary keys generated by the SHO A-server for a particular stream that it generates are used by the clients in all the ad zones to decrypt the advertising data inserted streams that were generated by the local advertising data insertion unit from the stream generated by the SHO A-server. An illustrative embodiment includes a multicast regenerator, which resides near or is integrated with an advertising data insertion unit. The multicast streams from the SHO are input to the regenerator. The regenerator buffers the streams, runs R-UDP with the SHO A-server for lost packet recovery, then passes the streams to the advertising data insertion unit.

In a particular illustrative embodiment, the advertising data insertion unit restamps the RTP sequence number, so its output streams are in sequence number order without any discontinuities. In the illustrative embodiment, the multicast regenerator function is integrated with the advertising data insertion unit. Alternatively, it could run in separate hardware, but that would have additional hardware, port costs, and operational implications.

The distribution server (D-Server) receives the output of the advertising data insertion unit, to support client reliable user datagram protocol (R-UDP) and IPTV's instant channel change (ICC) on the ad inserted streams. Without the multicast regenerator or other measures, R-UDP between the D-server and SHO A-server would not work, since the RTP sequence number space of the output of the advertising data insertion unit is generally not the same as that from the SHO. The reason for this is that the number of packets in an ad is not necessarily the same as that of the original program stream that it is overwriting. Typically, the probability that the number of packets matches is extremely small. Another illustrative embodiment further includes local advertising data insertion that occurs in the IOs. The concepts presented here are easily extended to apply to IO-based or CO-based advertising data insertion. IO-based insertion results in less bandwidth consumption on the VHO to IO links due to the ad inserted streams, compared to VHO based insertion. But VHO based insertion has the benefit of fewer servers to manage and more consolidated operations.

Consider a single national channel subject to local ad insertion, in which a SHO A-server generates a multicast stream with source and group (S-SHO, G). The multicast regenerator sends IGMPv3(S-SHO, G) report messages (also referred to as report join requests or simply join requests) to request this stream. It runs R-UDP for lost packet recovery then forwards the stream to the advertising data insertion unit. If the multicast regenerator only supported IGMPv2, then SSM-Translation (G->S-SHO), which associates S-SHO with G), would need to be configured on the IO router.

The advertising data insertion unit generates a separate advertising data inserted channel for each zone. These channels are multicast streams identified as (S-Ad (z), G), where (z) is an index that identifies the different ad zones, S-Ad(z) is the source address generated by the advertising insertion unit for a particular ad zone with index (z), and G is the same multicast group as generated by the A-server. In the implementation example, there are two zones (z=1 and 2), corresponding to two COs. The multicast source addresses are independent of the multicast egress interface address of the advertising data insertion unit, and are sometimes referred to as virtual source addresses. Virtual source addresses can be implemented in software.

In a particular illustrative embodiment in which the D-servers reside in the IO, the D-servers send IGMPv3(S-Ad(z),G) report message for each supported (z) to the IO router and subsequently receive the requested ad inserted streams. In the implementation example, this is shown as IGMPv3(S-Ad1,G) and (S-Ad2,G). In cases in which the D-servers do not support IGMPv3, static IGMPv3 could be configured on the interfaces of the IO router to which the D-servers are connected. In an illustrative embodiment, the D-servers for the advertising data inserted channels reside in the IOs. This has the advantage of being close to the advertising data insertion unit, so with proper quality of service (QoS) engineering, lost packet recovery would not be needed between the D-server and advertising data insertion unit. If the D-servers for non-ad channels reside in the VHO, and it is decided that local ad insertion resides in the IOs instead of in the VHOs, then the recommendation is to have separate D-servers for the ad-inserted channels, located in the IOs. In other implementation examples, the D-servers may be located remotely from the ad insertion units. That is, there are multiple router hops in the network between them. In these cases, if the network is not engineered to avoid packet loss when traversing those hops, then an additional R-UDP loop between the D-servers and ad insertion units would be used for lost packet recovery.

The IPTV client devices send IGMPv3(*,G) any source multicast (ASM) reports to the residential gateway (RG), where G is the same as that from the A-server, and run R-UDP and instant channel change ICC. The R-UDP implementation between clients and D-servers may be different than that between the multicast regenerator and the SHO A-servers. This would allow for customization of the operation according to the characteristics of the systems involved. In one typical embodiment, IGMPv2(*,G) runs from the upstream side of the RG to the DSLAM, and to the CO and to the IO. In another illustrative embodiment, IGMPv3(*,G) ASM (Any Source Multicast) equivalent can be used. An illustrative embodiment configures SSM-Translation of G to S-Ad(z) on each IO interface to a CO. In a particular illustrative embodiment, the boundary keys as generated by the A-server for a national channel are also used for all the subsequently generated ad inserted streams. This is transparent to the boundary key distribution mechanisms.

In a particular embodiment, extensions are provided in advertising data insertion units in an internet protocol television (IPTV) environment with D-servers. One such IPTV environment, among others, is provided by Microsoft Corporation (Microsoft). In a particular IPTV environment, distribution servers (D-servers) are provided that participate in R-UDP with the IPTV clients such as end user devices including but not limited to set top boxes, DVRs, PCs, and cell phone. Since a D-server supports multiple zones, the stream-identifier-data in the stream for a particular zone must be unique for the zone. This can be accomplished by an advertising inserter generating a unique stream-identifier-data for each zone.

In some designs for zone-based local advertising data insertion, the advertising data insertion system has an input stream with multicast group address G(i) for each national channel subject to local advertising data insertion, and the output is a multiplicity of advertising data inserted streams for each G(i), each with its own unique multicast group G(i,z), where z is a zone index (there is a different value for z for each zone). (Don's comment: this is true, but in this approach, with different Gs to the different zones for a given channel, ad insertion is not transparent to the clients or the access node devices. This patent avoids this problem, by making ad insertion transparent, and this is accomplished by using the same G for all the zones, for a given channel. We don't want the reader to think that the approach with different Gs to the different zones is what we are proposing or recommending.)

In an IPTV system in which the zones are CO based, a zone consists of one or several COs (Don's comment: this is true, but completely independent of the previous paragraph).

In an illustrative embodiment, for a given G(i) input to the local advertising data insertion system, all the advertising data insertion unit's output streams for the zones have the same multicast group G(i) as the input. In an illustrative embodiment, for a given G(i), there is no need to generate separate boundary keys (which are used to decrypt the audio and video data) for the advertising data inserted streams of the multiple zones. The original boundary keys and G(i) as generated by the SHO A-server are used for all the advertising data inserted streams of the multiple zones, for this G(i).

In another particular embodiment, a computer readable medium is disclosed containing embedded computer executable instructions that when executed by a computer are useful in performing a method for sending targeted advertising data, the computer program comprising instructions to receive a first data set at a server; instructions to duplicate the data set to form a number, N of duplicated data sets, wherein N equals the number of zones to which advertising data will be sent; instructions to replace a source address in each of the N duplicated data sets with a different data source addresses; and instructions to send each of the N duplicated data sets to a different end user zone. In another embodiment of the medium, the instructions to send further include instructions to send the data sets to a router for redirecting each of the N data sets to one of the different end user zones.

In another embodiment of the medium, the computer program further comprises instructions to add one of a number, M different advertising data sets to each of the N duplicated data sets. In another embodiment of the medium, the number of advertising data sets or advertisements, M does not have to equal the number of zones, N. In another embodiment, the number of advertisements, M is not equal to the number of zones, N. In another embodiment, the number of advertisements M, is equal to the number of zones, N.

In another embodiment of the medium, the first data set is an internet protocol television (IPTV) video multicast data stream that is multicast from a super hub office (SHO) server to an Intermediate Office (IO) server in an IPTV system and the source address is the multicast source address, S for the multicast data stream. In another embodiment the first data set includes but is not limited to an SSRC address in a real time protocol transport header for the data stream. Use of the SSRC is one example of data that can be used to distinguish the different streams going to the different zones for the purposes of the R-UDP packet recovery protocol, however, there are other data that can be used to distinguish the different streams for the purposes of R-UDP. (I recommend deleting this).

In another illustrative embodiment, a computer readable medium containing embedded computer executable instructions that when executed by a computer are useful in performing a method for sending targeted advertising data, the computer program comprising instructions to receive a number N of data sets, each of the N data sets having a different source address; and instructions to send each of the N data sets to a different destination based on the unique source address in each of the N data sets. In another embodiment of the medium, the N data sets are data streams multicast from a central office (CO) server or intermediate office (IO) server in an internet protocol television (IPTV) system to a router, wherein the router redirects each of the N data streams to a different set of end user devices associated with a different end user zone based on the source address in the Nth data stream.

In another particular embodiment, a system for sending targeted advertising data is disclosed, the system comprising a processor in data communication with a computer readable medium; and a computer program embedded in the computer readable medium, the computer program comprising instructions to receive a first data set at a server; instructions to duplicate the data to form N duplicated data sets; instructions to replace a source address in each of the N duplicated data sets with a different one of a number, N data source addresses; and instructions to send each of the N duplicated data sets to a different end user zone. In another particular embodiment of the system, the instructions to send further comprise instructions to send the duplicated data sets to a router for redirecting each duplicated data set to one of the different end user zones.

In another particular embodiment of the system the first data set is a multicast data stream. In another particular embodiment of the system the first data set is an internet protocol television (IPTV) video multicast data stream that is multicast from a super hub office (SHO) server in an IPTV system and the source address is the multicast source address, S for the multicast data stream.

In another particular embodiment of the system the advertising data are added to the IPTV data stream at the CO. In another particular embodiment of the system the first data set is an IPTV video data stream multicast from an IPTV system SHO server to a CO. In another particular embodiment another system is disclosed for sending targeted advertising data, the system comprising a processor in data communication with a computer readable medium; and a computer program embedded in the computer readable medium, the computer program comprising instructions to receive a number N of data sets, each of the N data sets having a different source address; and instructions to send each of the N data sets to a different destination based on the unique source address in each of the N data sets.

In another particular embodiment of the system, the N data sets are data streams multicast from a central office (CO) in an internet protocol television (IPTV) system to a router, wherein the router redirects each of the N data streams to a different set of end user devices associated with a different end user zone based on the source address in the Nth data stream. In another particular embodiment a data structure embedded in a computer readable medium is disclosed, the data structure comprising a first field for containing data indicative of an end user zone identifier (this is the multicast group address, which indicates the TV channel that some set of end users is viewing); and a second field for containing data indicative of source identifier (this is the multicast source address, which is used to distinguish the different ad inserted streams for the different zones that the various end users reside in). (note—this was deleted since it was already noted earlier in the same sentence)

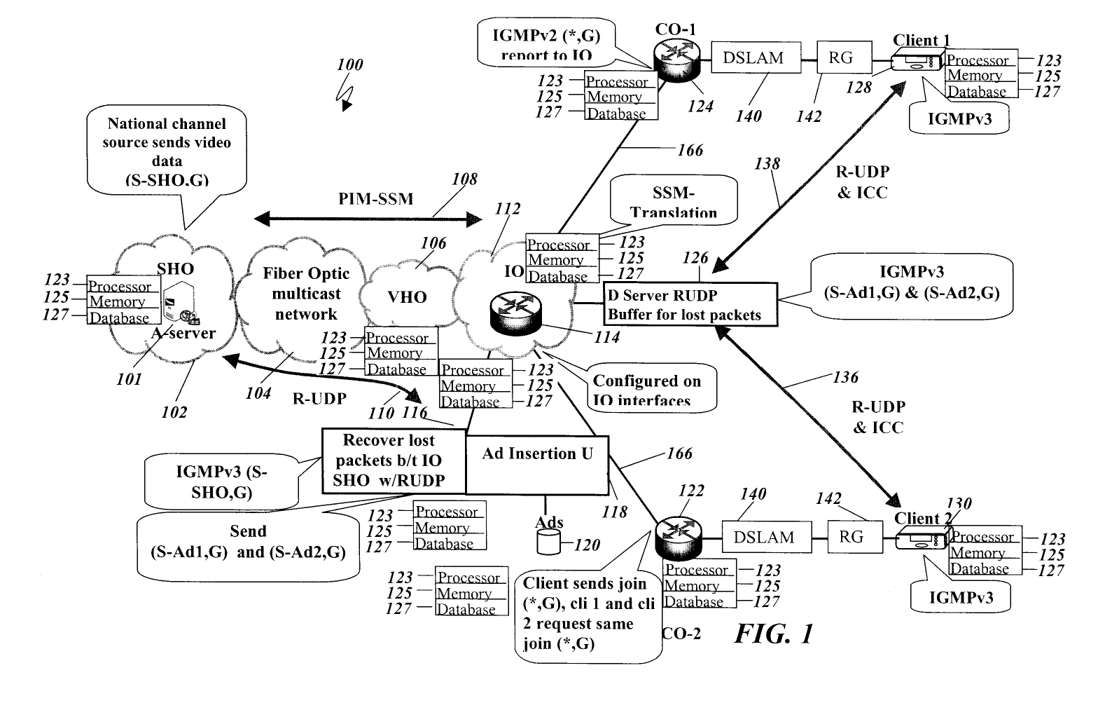

Turning now to FIG. 1, in another particular embodiment an IPTV super hub office (SHO) 102 provides video data from an A-Server 101 to an Internet Protocol (IP) backbone network 104 which can be any IP multicast network, including but not limited to high speed fiber optics in combination with satellite and cellular/mobile communication networks or some other multicast our unicast communication network which provides the video data from a video source such as the SHO 102 to a video hub office (VHO) 106. The VHO 106 provides the video data to an intermediate office (IO). The video data is provided in multicast data stream format to a regenerator device 116 within the IO 112. The video data from the VHO is provided to the multicast regenerator 116 which recovers lost data packets between the SHO and IO using R-UDP 110 between the SHO and the IO.

Another illustrative embodiment also performs protocol independent multicast source specific multicast (PIM-SSM) 108 between the SHO and IO. PIM-SSM is an extension of the PIM protocol. With SSM, both the multicast source and the multicast group are carried in the PIM join and prune messages. The video data is then provided to the advertising insertion unit 118. The video data entering the multicast regenerator has an IP source address S-SHO and multicast group address Gat the advertising insertion unit. The video data is then replicated by the advertising insertion unit for each different advertising data item (advertisement) added that will be inserted into the multicast video data stream. In this example, for simplicity, there are only two end user zones shown, each with a single client device associated with a single end user. An end user zone is that group of end users associated with a particular zone, as those end users associated with a particular CO.

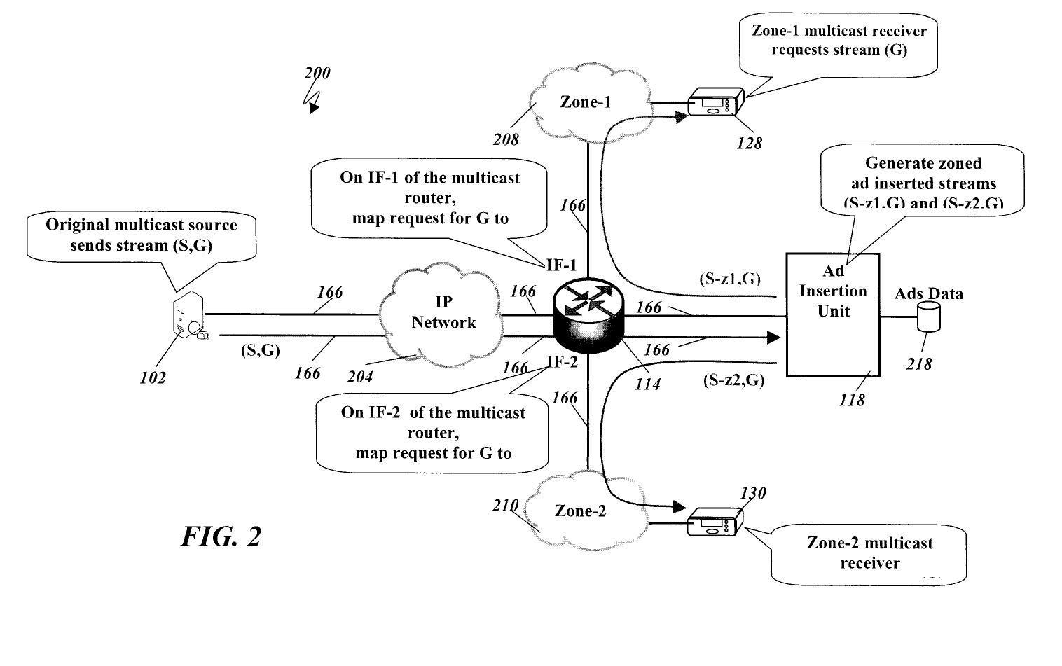

As shown in FIG. 1, a first end user zone having a member client 1 128 is associated with CO-1 124 and a second end user zone having a member client 2 130 is associated with CO-2 122. Each CO 122, 124 communicate with client device 128 and 130 via a digital subscriber line access multiplexer (DSLAM) or passive optical subscriber line splitters/multiplexer 140 and a gateway such a residential gateway (RG) 142. There can be numerous end user zones each having numerous members each end user can be associated with numerous end user devices which are also referred to as client devices. Each of the SHO 102, VHO 106, IO 112, IO router 114, A-server 101, D-server 126, advertising insertion unit, and end user devices (client devices) shown in FIG. 1 and FIG. 2 include a processor 123, computer readable medium 125, memory, data structures/data base 127 embedded in the computer readable medium and computer programs including computer executable instructions embedded in the computer readable medium. The router 114 sends data to CO-2 122 over IPTV transport 166 and sends data to CO-1 124 over IPTV transport 166.

The advertising data insertion unit places a first advertising data item in a first multicast data stream and changes the source address for the first multicast data stream to a unique value so that the multicast data stream that entered the regenerator 116 is now replicated by the ad insertion unit into two multicast data streams, the first data stream having a new multicast source address of (S-Ad1, G) and the second data stream having a new multicast source address of the (S-Ad2, G). Different advertisements or different advertising data are retrieved from the advertising database 120 and inserted into each of the two new multicast data streams regenerated by advertising insertion unit 118. The two new regenerated multicast data streams with new source addresses are then sent to the router 114.

The router reads the source address in the data stream and forwards the data stream to its multicast egress interfaces based on the data stream multicast source address and multicast group address. A first interface on the router 114 is configured to send video data (multicast) that have a source address of (S-Ad1) to CO-1 124 and video data having a source address of (S-Ad2) to CO-2 122. While the present example is a video data stream, the video example is not meant to be limiting as the data sets can be streams or other data formats and may include other data types including but not limited to audio, text, MPEG, and other types of data. The video data with source address S-Ad1 sent to CO-1 is then sent to client device 1 128 in the end user zone associated with CO-1, as a result of client device 1 or end user device 1 sending an IGMPv2(*,G) report join request for multicast address G. Likewise the video multicast data with source address S-Ad2 are sent to CO2 or to a client device (end user device) belonging to a second end user zone associated with CO-2 when client or end user devices in the second end user zone send an IGMPv2(*,G) report join request for multicast address G.

Thus, the end users in both zones send the same multicast join request, but each receives different multicast data containing different advertising data for the IPTV channel they selected. In an illustrative embodiment the new multicast streams generated by the ad insertion unit are also sent to the D-server 126 where the data are buffered and provide for R-UDP services for recovery of lost packets between the D-server 126 and client device 128 represented by the R-UDP communication path 138 and between D-server 126 and client device 130 represented by the R-UDP communication path 136.

Turning now to FIG. 2 in another illustrative embodiment, a multicast source 102 sends data from A-server 102 to a router 114 over IP network 204. The original multicast stream having a source address (S) and a group address (G) is replicated, advertising data is inserted from advertising data unit 118 into the two replicated streams, the source identifier (source address) in the two replicated streams is replaced with distinct source address values, and the new multicast data sent to an IP router 114. The router forwards the data based on the newly inserted source address and the multicast group address G. A first interface, IF-1 on the multicast/unicast router 114 and a second interface (IF-2) are provided on the multicast/unicast router. The router 114 maps requests for G to a request for (S-z2, G) for CO-2 (zone 2) 210 to the end user zone associated with client 2 130 and to a request for (S-z1, G) for CO-1 (zone 1) 208 to the end user zone associated with client 1 128.

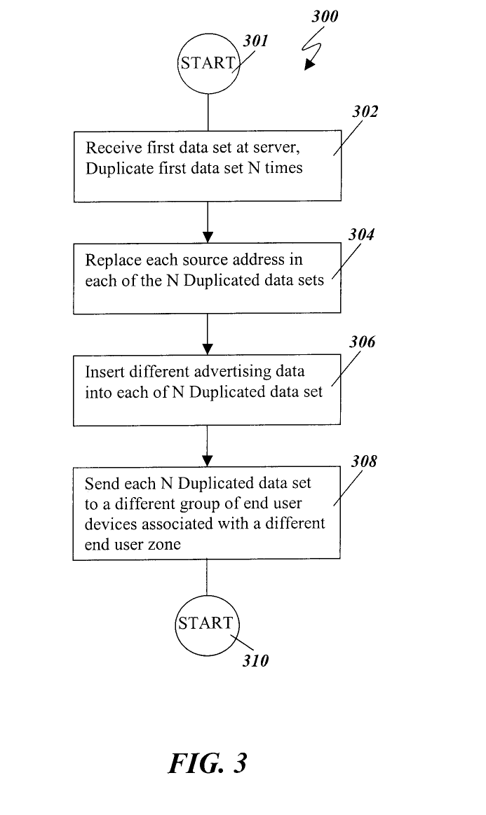

Turning now to FIG. 3, in another particular illustrative embodiment a flow chart of functions is performed as shown in FIG. 3. In the flowchart of FIG. 3, 302 must be first in order of execution, and 308 must be last in order of execution. As shown in FIG. 3, the flowchart of FIG. 3 starts at terminal 301 and proceeds to block 302 where a particular illustrative embodiment further receives data at a server and duplicates the data N times. This data can be a video data stream multicast in an IPTV system from a SHO to an IO.

Proceeding to block 304 an embodiment replaces each source address in each of the N duplicated data streams with a unique source code address that is different from all other source addresses used for the others N data streams. An illustrative embodiment then proceeds to block 306 and inserts different advertising data into each of the N duplicated data streams. An illustrative embodiment then proceeds to block 308 and sends each duplicated data stream to a different end user zone according to the multicast group address and unique source address contained in the header for the Nth duplicated data stream. In the illustrative embodiment, the process ends at terminal 310.

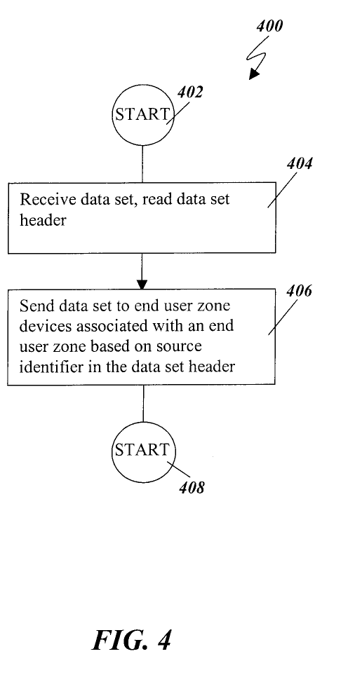

Turning now to FIG. 4, an illustrative flowchart of functions performed at a router or another device is illustrated in FIG. 4. The functions in the flowchart of FIG. 4 begin at terminal 402 and proceed to block 404 where a router or other data receiving device receives data sets from a server or other transmission device. Another illustrative embodiment reads a data header for the data sets received. An illustrative embodiment then proceeds to block 406 where it sends data to end user devices or client devices associated with end user zones (zones) based on the zone independent stream identifier (multicast group) and zone specific source identifier in the data set header. The illustrative flow chart ends at terminal 408.

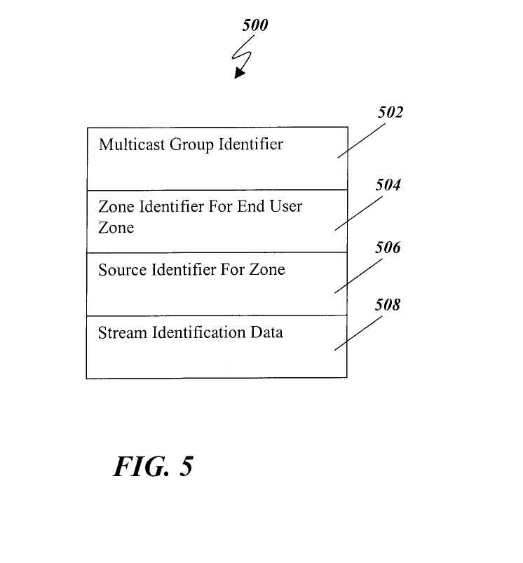

Turning now to FIG. 5, an illustrative embodiment of a data structure embedded in a computer readable medium is provided for containing data useful in performing the functions and methods of the disclosed invention. As shown in FIG. 5, the data structure 500 provides a first data structure field 502 for containing data indicative of a multicast group identifier. A multicast group identifier is used to identify a channel in an IPTV system. All end users watching a particular channel are receiving streams containing the same multicast group identifier. As shown in FIG. 5, a second data structure field 504 is provided for containing zone identifier data indicating a zone located office (such as a CO or IO) or collection of such offices, all of which reside in a particular ad zone.

As shown at 506 a third data structure field is shown for containing data indicative of a source identifier for the zone identifier 504. The source identifier 506 for along with the multicast group identifier is used by the router to determine how multicast packets are to be forwarded out its egress interfaces to the appropriate zones. The stream identifier 508 is data carried inside each stream that is used by IPTV D-servers and by IPTV clients to uniquely identify streams in a way that does not necessarily depend directly on the multicast group identifier or zone identifier or source identifier.

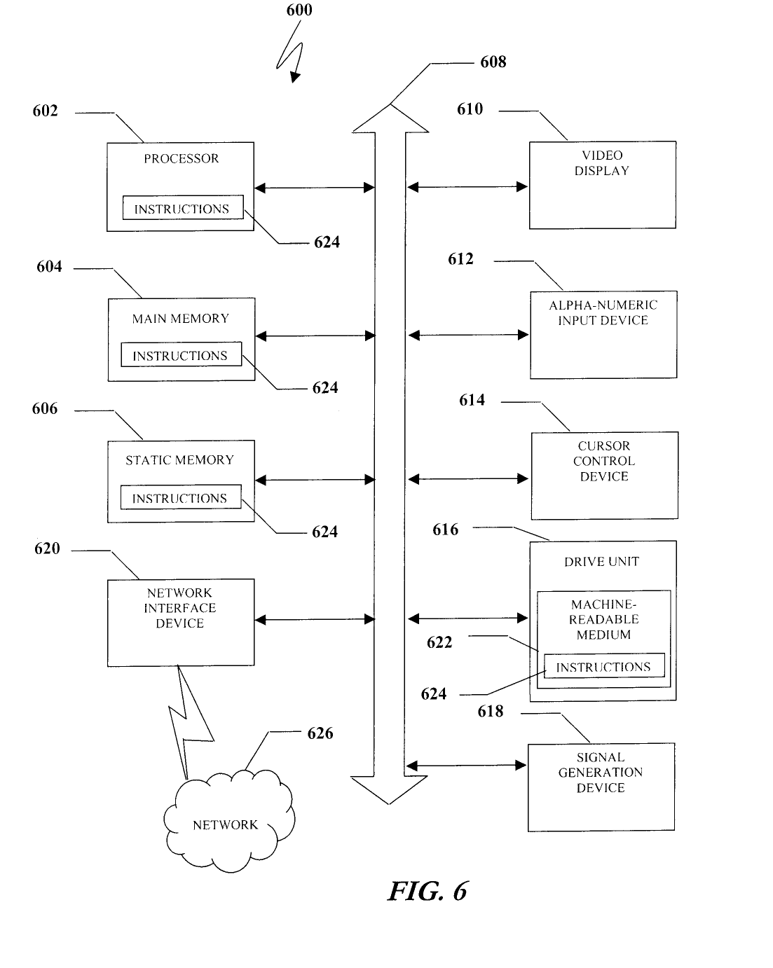

FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine.

It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein. The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., liquid crystals display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor, which may reside in a server or a network element, such as a router or switch. Furthermore, software implementations can include, but not limited to, distributed processing or component/object distributed processing, parallel processing, or virtual machine processing can also be constructed to implement the methods described herein.

The present invention contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620. The machine readable medium may also contain a data structure for containing data useful in providing a functional relationship between the data and a machine or computer in an illustrative embodiment of the disclosed system and method.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer readable medium containing an embedded computer program of executable instructions that when executed by a computer or router or switch are useful in performing a method for sending targeted advertising data, the computer program comprising:
instructions to receive a first data set at a server;
instructions to duplicate at the server, the first data set to form N duplicated data sets;
instructions to replace an original source address in each of the N duplicated data sets with a different one of a number, N new data source addresses; and
instructions to send from the server, each of the N duplicated data sets to a different end user zone based on the new source addresses.

2. The medium of claim 1, wherein sending further comprises sending the data sets to a router for redirecting each data set to the different end user zones based on the new source address.

3. The medium of claim 1, the computer program further comprising:
instructions to add one of a number, M different advertising data sets to each of the N duplicated data sets.

4. The medium of claim 1, wherein the first data set is an IP multicast data stream, in which the multicast source address and multicast group address are carried in the source and destination address fields in header of the IP packets.

5. The medium of claim 1, wherein the first data set is an internet protocol television (IPTV) video multicast data stream that is multicast from a super hub office (SHO) server to a video hub office (VHO) in an IPTV system and the source address is the multicast source address, S for the multicast data stream.

6. The medium of claim 5, wherein the advertising data are added to the IPTV data stream at the video hub office (VHO), or at an intermediate office (IO), or at a central office (CO), or any other location within the multicast distribution tree.

7. A computer readable medium containing an embedded computer program of executable instructions that when executed by a computer or router or switch are useful in performing a method for sending targeted advertising data, the computer program comprising:
instructions to receive a number N of data sets, each of the N data sets having a different source address; and
instructions to send each of the N data sets to a different destination based on the unique source address in each of the N data sets.

8. The medium of claim 7, wherein the N data sets are data streams multicast from a SHO in an internet protocol television (IPTV) system to a router, wherein the router redirects each of the N data streams to a different set of end user devices associated with a different end user zone based on the source address in the Nth data stream.

9. A system for sending targeted advertising data, the system comprising:
a processor in data communication with a computer readable medium; and
a computer program embedded in the computer readable medium, the computer program comprising:
instructions to receive a first data set at a server;
instructions to duplicate the first data to form N duplicated data sets;
instructions to replace an original source address in each of the N duplicated data sets with a different one of a number, N new source addresses; and
instructions to send each of the N duplicated data sets to a different end user zone based on the new source address in the duplicated data set.

10. The system of claim 9, wherein sending further comprises sending the data sets to a router for redirecting each data set to the different end user zones based on the new source address.

11. The system of claim 9, the computer program further comprising:
instructions to add one of a number, M different advertising data sets to each of the N duplicated data sets.

12. The system of claim 9, wherein the first data set further includes an SSRC in a real time protocol header for the data stream.

13. The system of claim 9, wherein the first data set is an internet protocol television (IPTV) video multicast data stream that is multicast from a super hub office (SHO) server to a video hub office (VHO) in an IPTV system and the source address is the multicast source address, S for the multicast data stream.

14. The system of claim 13, wherein the advertising data are added to the IPTV data stream at the VHO.

15. A system for sending targeted advertising data, the system comprising:
a processor in data communication with a computer readable medium; and
a computer program embedded in the computer readable medium, the computer program comprising instructions to receive a number N of data sets, each of the N data sets having a different source address; and
instructions to send each of the N data sets to a different destination based on the different source address in each of the N data sets.

16. The system of claim 15, wherein the N data sets are data streams multicast from a video hub office (VHO) ad insertion device in an internet protocol television (IPTV) system to a router, wherein the router redirects each of the N data streams to a different set of end user devices associated with a different end user zone based on the source address in the Nth data stream.

17. A data structure embedded in a computer readable medium, the data structure comprising:
a first field for containing data indicative of an end user zone identifier; and
a second field for containing data indicative of source identifier for the end user zone for mapping data having the source identifier to end user devices associated with the end user zone.
